(19) United States
(12) Patent Application Publication
(10) Pub. No.: US 2024/0240505 A1
(43) Pub. Date: Jul. 18, 2024

(54) MOTOR VEHICLE COMPRISING A SIDE DOOR

(71) Applicant: Dr. Ing. h.c. F. Porsche Aktiengesellschaft, Stuttgart (DE)

(72) Inventor: Tassilo HEILMANN, Pforzheim (DE)

(21) Appl. No.: 18/413,068

(22) Filed: Jan. 16, 2024

(30) Foreign Application Priority Data
Jan. 18, 2023 (DE) 10 2023 101 136.7

(51) Int. Cl. E05F 15/611; B60J 10/86; B62D 25/04; E05B 85/10

(52) U.S. Cl. CPC E05F 15/611; B60J 10/86; B62D 25/04; E05B 85/103; E05Y 2201/11; E05Y 2900/53

(57) ABSTRACT

A motor vehicle includes a side door, an upwardly open recessed handle, and a cover flap. The upwardly open recessed handle is arranged on the side door or on the motor vehicle. The cover flap is pivotably arranged on the side door to cover the recessed handle. The cover flap has an outward slope in a closed position.

### CROSS REFERENCE TO RELATED APPLICATIONS

This application claims benefit to German Patent Application No. DE 10 2023 101 136.7, filed on Jan. 18, 2023, which is hereby incorporated by reference herein.

### FIELD

The present invention relates to a motor vehicle comprising a side door.

### BACKGROUND

FR 3 096 713 A1 discloses a motor vehicle of said type, comprising a side door in which a B-pillar is recessed and, together with a side door, forms a recessed handle in which an actuating device for a door lock is arranged. The disadvantage of this vehicle, however, is that water runs along the B-pillar into the recessed handle when it rains and has to be drained from there, which means that moisture or water gets into the recessed handle every time it rains and can at least encourage corrosion processes there. Another disadvantage is that the outer skin of the side door is interrupted, which can have a negative impact on the visual appearance and a cW value.

DE 101 34 993 A1 discloses a door handle comprising a recess accessible from the outside, the recess having a base and a side wall. An outer region of the side wall is adjoined by a solid wall region that partially covers the recess and forms the door handle. A free space is formed between the solid wall region and the base of the trough, which allows an operating hand to reach behind the solid wall region. This is intended in particular to make it easier to move the vehicle door when the door lock is open.

DE 10 2004 042 545 A1 discloses a door handle device comprising a door handle that is arranged on a rear door of an automobile such that it can be freely pivoted. In addition, a cover part is provided to cover the door handle, in which case a sensor for detecting the approach of an operating person in the direction of the door handle is provided between the door handle and the cover part.

DE 10 2006 027 473 A1 discloses an actuating device for an electromechanical lock of a movable part of a motor vehicle, comprising a housing and a movable protective flap, whereby a user can engage in the actuating device and operate an actuating element provided in the housing.

DE 10 2018 106 657 A1 discloses a door handle module for a movable part of a vehicle, comprising a handle carrier which can be mounted on the outer skin of the movable part, a handle which is movably mounted on the handle carrier and has an actuating mechanism which can be at least in sections concealed by the outer skin, and a sensor unit. The actuating mechanism in this case works together with a lock or a lock drive. The sensor device, which comprises at least one sensor element, can be used to detect a user's intentions in an actuation region of a door handle recess, whereby the lock or the lock drive can be electrically actuated when a user's intentions are detected in the actuation region. This is intended to provide mechanical redundancy for the operation of a vehicle lock.

A handle system for opening a motor vehicle comprising an access hatch is known from EP 1 402 138 B1, in which the hatch has a sensor capable of detecting the presence of a hand or finger in the vicinity of the hatch so that the hatch automatically retracts at the moment the user's hand uses the handle.

In general, door handles and door locks on the side doors of motor vehicles are not just purely functional elements, but are also increasingly expected to meet design requirements, which is why a wide variety of door handle systems are being developed, some of which are highly complex. In order to thereby make it easy for a user to open the side door, a door handle is often placed on the outside of the outer skin and/or a recessed handle is recessed into the side door for the user to reach into. However, the disadvantage of these door handle systems is that they interrupt the outer skin of the side door, which can have a negative impact on the appearance. Another disadvantage of such door handle systems is increased air resistance, which is particularly important in sports car construction.

### SUMMARY

In an embodiment, the present disclosure provides a motor vehicle, comprising a side door, an upwardly open recessed handle arranged on the side door or on the motor vehicle, and a cover flap pivotably arranged on the side door to cover the recessed handle, wherein the cover flap has an outward slope in a closed position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a side view of a motor vehicle according to an embodiment of the invention in the region of a side door with an open cover flap;

FIG. 2 illustrates the side view of a motor vehicle of FIG. 1, but with the cover flap closed;

FIG. 3 illustrates a sectional view of a motor vehicle according to an embodiment of the invention in the region of the cover flap with an embodiment of an actuating device;

FIG. 4 illustrates a sectional view of a motor vehicle according to an embodiment of the invention in the region of the cover flap with a handle shell with a soft component and a metal profile injected into it;

FIG. 5 illustrates a sectional view of a motor vehicle according to an embodiment of the invention in the region of the cover flap with an actuating device with a microswitch; and

FIG. 6 illustrates a sectional view of a motor vehicle according to an embodiment of the invention in the region of the cover flap with a two-component handle shell with a soft component and a strain gauge as an actuating device.

### DETAILED DESCRIPTION

In an embodiment, the present invention provides an improved or at least an alternative motor vehicle featuring an improved cW value.

In an embodiment, the present invention integrates a door handle/closing system into the side door of a motor vehicle, instead of a door handle/closing system which was heretofore mounted on the outside of the door, and enables operation via a recessed handle which is accessible from above and which is sealed by a cover flap when not in use. As a result, it is easy for a user to reach into the recessed handle and open the vehicle door or side door, while at the same time the upwardly open recessed handle is sealed by the cover flap when not in use, so that an outer skin contour of the vehicle door is continuous and can therefore be designed to be particularly favorable in terms of air resistance. The vehicle in this case comprises the aforementioned side door, in which the upwardly open recessed handle is arranged. On the vehicle itself, e.g. on a B-pillar or on the side door, a pivotably arranged cover flap, in particular one that pivots about a horizontal pivot axis, is provided to cover the recessed handle. In a closed position, the cover flap in this case features an outward-facing slope, which means that rain can simply be guided over the cover flap and thus the recessed handle, and drained away via the outer skin of the side door. The cover flap seals the recessed handle in a preferably flush manner with the surface of the outer skin surrounding the cover flap, which means that there is no surface interruption in the region of the recessed handle, which is particularly advantageous for a cW value (air resistance). The upwardly open recessed handle makes it comparatively easy to open the side door, as a user only has to insert their fingers into the recessed handle and activate an actuating device arranged in it to operate a door lock. The cover flap, which slopes outwards in its closed position and preferably seals the recessed handle in a watertight manner, can also prevent or at least reduce the inadvertent ingress of water into the recessed handle, thereby reducing the risk of corrosion.

In an advantageous embodiment of a motor vehicle according to the invention, the recessed handle is at least partially lined with a plastic shell. Such a plastic shell can, e.g., be painted in the color of the car and/or have a special feel, which can create a special design effect. A special feel, in particular a roughened surface, can also improve the grip on the side door, making it easier to open. Such a plastic shell can also be produced comparatively inexpensively as a plastic injection-molded part and can comprise a drain that enables water to be reliably drained from the recessed handle in the event of unwanted water ingress, e.g. when the side door is opened with snow on the cover flap, or in the event of rain. This not only reduces the risk of corrosion, but also increases comfort for the user, as they do not have to reach into a wet recessed handle.

Additionally or alternatively, a lighting device can be arranged in the recessed handle. This type of lighting device increases the user's sense of safety, as they do not have to reach into an unlit space. A vibration device can also be arranged in the recessed handle, which provides haptic feedback when the actuating device is successfully actuated.

In an advantageous embodiment of a motor vehicle according to the invention, the recessed handle and/or the cover flap comprise(s) a seal via which the cover flap seals the recessed handle in its closed position. As a result, when the vehicle is not in use and the user is not reaching into the recessed handle, the recessed handle can be sealed tightly, reliably preventing the ingress of moisture or water. Preventing water from entering the recessed handle can also reduce the risk of corrosion.

In a preferred embodiment of a motor vehicle according to the invention, the cover flap is pretensioned in its closed position by means of a spring. To open the vehicle door, a user presses on the cover flap from above and opens it so that they can reach into the recessed handle. Once the vehicle door is open, the user can pull their fingers out of the recessed handle, whereupon the spring-loaded cover flap closes automatically. The spring force is such that the user can easily press down the cover flap to open the side door, while the cover flap reliably closes upwards once the fingers have been removed from the recessed handle.

Additionally or alternatively, the cover flap can also be driven electrically or magnetically. In an electric drive, an electric motor can, e.g., be provided which automatically moves the cover flap downwards when a remote control key approaches the vehicle, thereby opening the recessed handle. A coil can be provided for a magnetic drive, while a ferromagnetic material is, e.g., arranged in the cover flap. In this case, the cover flap can also be opened automatically if a driver approaches with their authentication device, e.g. a remote control key or smartphone, or if the vehicle is placed in a parking position so that it can be conveniently accessed without manually operating the cover flap. In the event of a power failure, the cover flap can be pressed down manually without any problems, even with an electric motor or magnetic drive, to enable emergency opening of the side door or vehicle door, especially for rescue services.

In an advantageous embodiment of a motor vehicle according to the invention, the recessed handle is formed by an outwardly sloping inner door panel which is flanged to an outer door panel. As a result, it is comparatively easy to produce the recessed handle by reshaping the inner door panel. In addition, the recessed handle can be enlarged by a recess in a panel, in particular a B-pillar. Such a recess in, e.g., the B-pillar of the vehicle, enables the recessed handle to be enlarged, particularly in terms of its depth, which reliably prevents fingernails from being damaged when reaching into the recessed handle.

In a preferred embodiment of a motor vehicle according to the invention, an actuating device for a door lock is arranged in the recessed handle. The actuating device is preferably arranged on an outer inner surface of the recessed handle, making it easy to operate when gripping with the fingers and pulling the side door outwards. For example, a handle shell having a soft component can be arranged in the recessed handle, whereby a strain gauge of the actuating device is integrated in the soft component. The driver's fingers engaging in the recessed handle pull on the side door to open it, causing a slight pressure on the handle shell comprising the soft component and the strain gauge, which then transmits a signal to an electric door lock based on the detected deformation, whereupon the door lock is opened. In addition, a metal profile can be injected into the soft component, which makes a selective force of a finger pressing on it usable as a displacement over a larger region for a sensor. The sensor for triggering the door lock can be a microswitch.

Alternatively, it is of course also possible for the actuating device to comprise a pivoting lever that is operatively connected to a strain gauge. In this case, the lever, which is, e.g., pivotably mounted via a pivot axis, is pressed, whereby the lever causes an expansion of the strain gauge at the other end, similar to a rocker, whereupon the door lock is opened. Of course, such a pivoting lever can also act directly on a microswitch to operate the door lock.

In a preferred embodiment of a motor vehicle according to the invention, the recessed handle in the side door is open towards the rear of the vehicle. Rearward sealing is, e.g., therefore achieved by a rear door or a body part located behind the side door in the direction of travel, such as a mudguard. This offers the great advantage that a separate drain can be omitted if, e.g., a base of the recessed handle is slightly inclined towards the rear end of the recessed handle so that any water that inadvertently enters the recessed handle can drain away automatically.

Further important features and advantages of embodiments of the invention follow from the dependent claims, the drawings, and the accompanying figure description in relation to the drawings.

It is understood that the features specified hereinabove and those yet to be explained hereinafter can be used not only in the respectively specified combination, but also in other combinations, or on their own, without departing from the scope of the invention as defined by the claims. The components described hereinabove and referred to hereinafter of a higher-level unit, e.g., a device, an apparatus, or an assembly, which are designated separately, can constitute separate parts or components of this unit, or integral regions or sections of this unit, even if shown differently in the drawings.

Preferred exemplary embodiments of the invention are set forth in the drawings and will be explained in further detail in the description below, whereby identical reference characters refer to identical, similar, or functionally identical components.

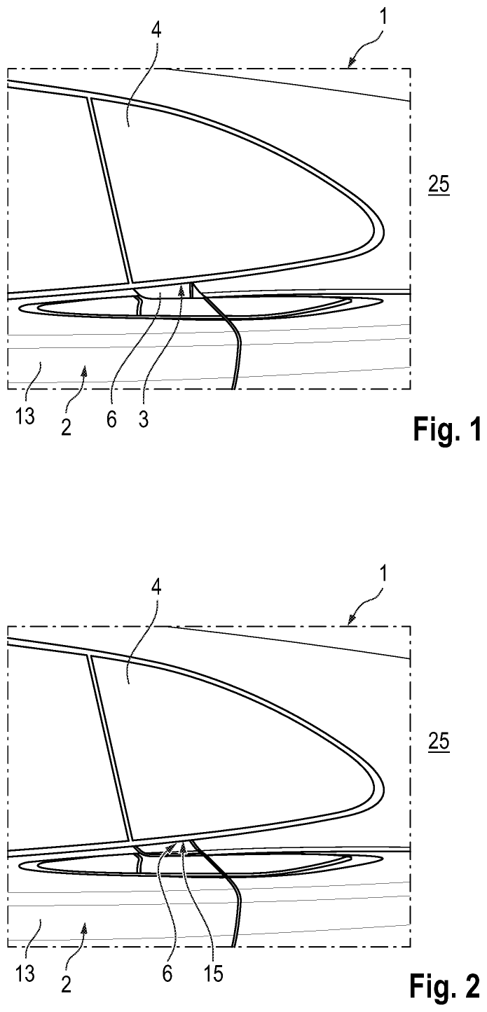

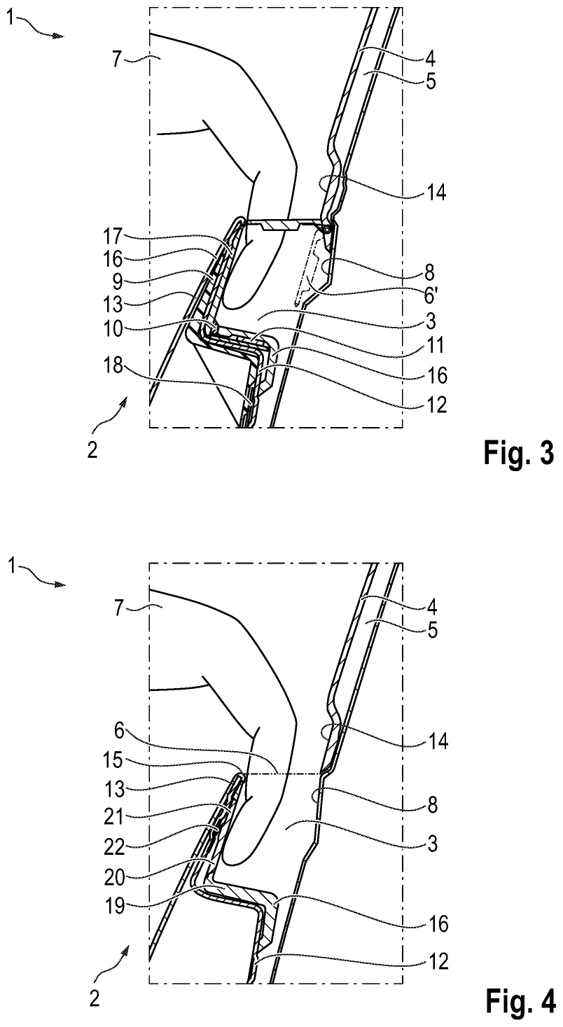

According to FIGS. 1 through 6, a motor vehicle 1 according to an embodiment of the invention comprises a side door 2, which in the present case is designed as a driver's door, but theoretically the side door 2 can of course also be a passenger door or a rear door. An upwardly open recessed handle 3 is arranged in the side door 2, whereby a cover flap 6 arranged on the motor vehicle 1, e.g. on a panel 4 of a B-pillar 5, is provided to cover the recessed handle 3. The cover flap 6 is moved or pivoted into the recessed handle 3, as shown in FIG. 1, while it seals the recessed handle 3 as shown in FIGS. 2 and 3. In a closed position, as shown in FIGS. 2 and 3, the cover flap 6 features an outward slope, which allows water to drain easily from the cover flap 6 via the side door 2 and prevents undesirable dirt or water from entering the recessed handle 3, particularly while the vehicle is in motion.

To open the side door 2, a driver reaches into the recessed handle 3 with their fingers 7 and, e.g., moves the cover flap 6 from its position sealing the recessed handle 3 to a position resting against the B-pillars 5, as shown in FIG. 3 by reference character 6′. In order to impair the interior of the recessed handle 3 as little as possible, a recess 8 can be arranged in the B-pillar 5 and/or the panel 4 to at least partially accommodate the cover flap 6.

The cover flap 6 also enables uninterrupted passage through an external surface, which in particular favors a cW value. In addition, the cover flap 6 sealing the recessed handle 3 can significantly improve the design of the motor vehicle 1, as interfering contours on the outer skin of the motor vehicle 1 are avoided.

The cover flap 6 can in this case, e.g., be painted the same color as the vehicle so that it is visually inconspicuous when sealing in the recessed handle 3 (see FIGS. 2 and 3). The recessed handle 3 can also be at least partially lined with a plastic shell 9, which can also be painted the same color as the vehicle. Additionally or alternatively, a lighting device 10 (see FIG. 3) can also be arranged in the recessed handle 3, which can serve both as a locating aid and for psychological reassurance when reaching into the hidden recessed handle 3. Furthermore, a vibration device 11 can also be arranged in the recessed handle 3, which can provide haptic feedback when a door lock is successfully triggered.

The recessed handle 3 can be formed by an inner door panel 12 that extends outwards and is flanged with an outer door panel 13. The required engagement width of the recessed handle 3 in the transverse direction of the vehicle can in this case only be achieved by projecting the inner door panel 12 outwards or by additionally embossing or recessing 14 the panel 4 of the B-pillar 5 inwards. With this type of concept, the depth of a handle region can also be comparatively large and bumping with fingernails can be avoided. This provides a large and therefore good gripping surface, which is particularly useful for emergency opening or opening with bare hands in the event of icing.

The recessed handle 3 and/or the cover flap 6 can comprise a seal 15, via which the cover flap 6 seals the recessed handle 3 in its closed position (see FIGS. 2 and 3). In particular, it is as a result impossible or at least more difficult for dirt or water to penetrate the recessed handle 3.

The cover flap 6 can be pretensioned in its closed position by means of a spring, which ensures that the cover flap 6 is retained reliably and continuously closed when fingers 7 are not engaging in the recessed handle 3. Additionally or alternatively, it is also conceivable that the cover flap 6 can be moved electrically, e.g. by means of an electric motor, or magnetically, e.g. by means of coils and a ferromagnetic element arranged in the cover flap 6. If the cover flap 6 is driven electrically or magnetically, it can move into the recessed handle 3 as soon as, e.g., a driver approaches the vehicle 1 with their remote control key or smartphone.

An actuating device 16 for an unspecified door lock can be arranged in the recessed handle 3. According to FIG. 3, the actuating device 16 in this case comprises a pivotable lever 17, which is mounted to be rotatable or pivotable about an axis of rotation. The lever 17 can also be part of a plastic shell 9. The lever 17 can, e.g., be coupled to a strain gauge 18 so that, when the lever 17 is pressed by the finger 7, the lever 17 is interlocked or twisted about its pivot point and the strain gauge 18 is thus deformed. The strain gauge 18 detects the expansion and thus opens the door lock.

Regarding the embodiment shown in FIG. 4, it can be seen that a handle shell 19 having a soft component 20 is arranged in the recessed handle 3, whereby a strain gauge 18 or a metal profile 21 is arranged in the soft component 20, via which a microswitch 22 can be actuated. In this case, the handle shell 19 is designed as, e.g., a 2-component plastic component. The door lock can also be unlocked by operating the microswitch 22.

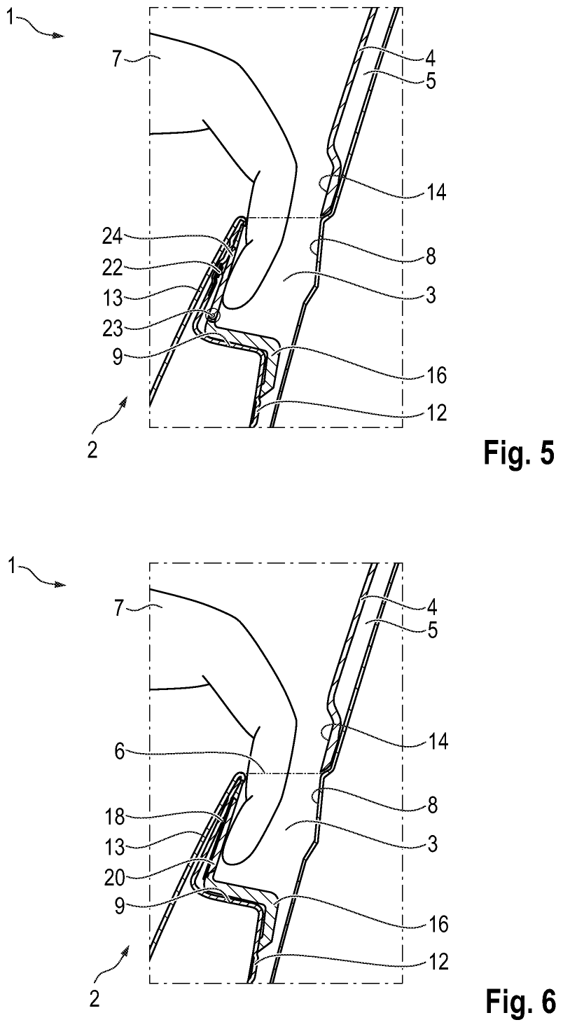

Regarding the embodiment shown in FIG. 5, an actuating device 16 can be seen, which comprises a section 24 that can be rotated about an axis of rotation 23 and can be pressed by the user's finger 7 against a microswitch 22, whereby the door lock is unlocked.

Regarding the embodiment of the actuating device 16 shown in FIG. 6, also seen is a handle shell 19 having a soft component 20, in which a strain gauge 18 is arranged. The strain gauge 18 is actuated directly by the user's finger 7.

As can be gathered from FIG. 1 in particular, the recessed handle 3 is open towards the rear of the vehicle 25, which makes it comparatively easy for water to drain out of the recessed handle 3.

All in all, the motor vehicle 1 according to embodiments of the invention can be used to create a door closing system, which in particular no longer comprises the interfering surfaces or openings heretofore present on an outer skin of the motor vehicle 1, as a result of which not only a particularly visually appealing design, but also a significantly improved cW value can be achieved. The cover flap 6, which seals the recessed handle 3, also makes it easy to reach into the recessed handle 3 with fingers 7 and at the same time ensures that the recessed handle 3 is sealed against dust and moisture.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A motor vehicle, comprising:
a side door;
an upwardly open recessed handle arranged on the side door or on the motor vehicle; and
a cover flap pivotably arranged on the side door to cover the recessed handle,
wherein the cover flap has an outward slope in a closed position.

2. The motor vehicle according to claim 1, wherein
the recessed handle is at least partially lined with a plastic shell, and/or
a light and/or a vibrator are/is arranged in the recessed handle.

3. The motor vehicle according to claim 1, wherein
the recessed handle and/or the cover flap comprise(s) a seal, via which the cover flap seals the recessed handle in the closed position.

4. The motor vehicle according to claim 1, wherein the cover flap is spring-loaded into the closed position, and/or wherein the cover flap is configured to be driven electrically or magnetically.

5. The motor vehicle according to claim 1, wherein the recessed handle is formed by an inner door panel which extends outwards and flanged to an outer door panel.

6. The motor vehicle according to claim 1, wherein a part of the recessed handle is additionally formed by a recess in a panel of a B-pillar.

7. The motor vehicle according to claim 6, wherein an actuator for a door lock is arranged in the recessed handle.

8. The motor vehicle according to claim 7, further comprising:
a handle shell having a soft component arranged in the recessed handle,
wherein a strain gauge of the actuator is integrated into the soft component, or wherein the actuator comprises a pivotable lever which is operatively connected to a strain gauge.

9. The motor vehicle according to claim 7, wherein the actuator comprises a microswitch.

10. The motor vehicle according to claim 1, wherein the recessed handle is open in a direction of a vehicle rear.
